(19) United States
(12) Patent Application Publication
(10) Pub. No.: US 2022/0299409 A1
(43) Pub. Date: Sep. 22, 2022

(54) Sample Tube And Device And Method For Dispersion And Homogenization

(71) Applicants: Swissmeca SA, Kleinbösingen (CH); Axon Lab AG, Baden-Dättwil (CH)

(72) Inventors: André BRUELHART, Kleinbösingen (CH); Maxime BRUELHART, Murten (CH); Guido MÜLLER, Alterswil (CH)

(21) Appl. No.: 17/692,707

(22) Filed: Mar. 11, 2022

(30) Foreign Application Priority Data
Mar. 16, 2021 (EP) 21162916.7

(51) Int. Cl. G01N 1/28; G01N 1/38; B01L 3/00; B01F 23/50; B01F 23/53; B01F 33/25; B01F 33/35; B01F 29/87

(52) U.S. Cl. CPC G01N 1/286; G01N 1/38; B01L 3/502; B01L 3/50825; B01F 23/51; B01F 23/53; B01F 33/253; B01F 33/35; B01F 29/87; B01L 2300/042; B01L 2300/046; G01N 2001/2866; B01F 2101/23

(57) ABSTRACT

A sample tube includes a cylindrical wall and a first end and a second end. The first end of the sample tube is closed by a base, such that a sample-receiving space with a longitudinal axis is formed between base and cylindrical wall. The second end has a closure piece connected releasably thereto. A weight element is received inside the receiving space and is shaped and dimensioned in such a way that the weight element can rotate freely in the receiving space only about the longitudinal axis of the latter. The application further relates to a method and a device with which a sample located in the sample tube can be dispersed or homogenized by rotational movement of the sample tube.

### CROSS-REFERENCE TO RELATED APPLICATIONS

This application claims the benefit and priority of European Application No. 211629167, filed on Mar. 16, 2021. The entire disclosure of the application referenced above is incorporated herein by reference.

### FIELD

The disclosure relates to a sample tube and to a device and a method for the dispersion and homogenization of a sample, in particular of a sample located in the sample tube.

### BACKGROUND

A great many sample tubes and devices and methods for the dispersion and homogenization of samples are known in the prior art. Particularly in the laboratory sector, homogenizers are used to disrupt cells. Here, the cells that are to be disrupted are generally transferred to test tubes or sample tubes. The cell disruption can take place through the introduction of mechanical energy, with the cell walls usually being destroyed by shear forces.

Various methods are known for introducing mechanical energy into the samples that are to be disrupted. In the Dounce method, for example, a pestle is moved back and forth at a short distance from the wall of the sample vessel. However, cells can also be disrupted by addition of milling bodies, for example glass beads, and by vibration of the sample on a vibrator. Moreover, mechanical energy can also be introduced into sample liquids by ultrasound in order to disrupt cells. A further possibility for cell disruption is to press a sample liquid at high pressure through a narrow valve (French press).

CH 710 352 (Franz Bucher) discloses, for example, a disposable container for mixing, homogenization, extraction, fractionation or suspension of sample material, with a cylindrical tube and a cover, the latter having a lid, a spiral cylinder and a plunger. Both the tube bottom and the plunger have radially arranged friction ribs. By means of a drive, the plunger can be moved in a vertical direction inside the tube and set in rotation in order to homogenize sample material.

U.S. Pat. No. 8,162,247 (Biomedical Polymers Inc.) describes a modular mortar system for comminution of samples. The mortar system comprises a tube with a base, which has a first grinding surface, and with a peripheral wall, which forms a sample-receiving space. A modular mortar set has an actuation shaft which at a distal end has a receptacle for different mortar heads, each of these having a second grinding surface, and at its proximal end has a holding device. The actuation shaft is guided through a screw-on lid, with which the tube can be closed.

U.S. Pat. No. 4,715,545 (Sage Products Inc.) relates to a system for comminution of tissue samples or the like, wherein the samples and also an operator of the system are protected from contamination. A sample can be introduced into the system and can be transported and also comminuted in the latter. The system comprises a tube with a closed base, which is designed as a grinding surface, and a mortar device which can be inserted into the tube. The tube can be closed by a screw-on lid. Prior to the comminution, the screw-on lid is removed and the mortar device is inserted into the tube. To reduce the risk of contamination, the mortar device has a protective sheath which can be pushed on over the tube.

However, a disadvantage of most methods is that the inadequate cleaning of the devices used in the methods can lead to cross-over and contamination. It is therefore advantageous to be able to use disposables for the cell disruption and for the homogenization and dispersion.

### SUMMARY

The problem addressed by the disclosure is to make available a sample tube belonging to the technical field mentioned at the outset, said sample tube providing a closed system for the dispersion and homogenization of samples with the risk of cross-over and contamination. The problem addressed by the disclosure is also to make available a corresponding method for the dispersion or homogenization of a sample.

According to the disclosure, the sample tube has a cylindrical wall and a first end and a second end. The first end of the sample tube is closed by a base, such that a sample-receiving space with a longitudinal axis is formed between base and cylindrical wall. The second end has a closure piece connected releasably thereto. A weight element is received inside the receiving space and is shaped and dimensioned in such a way that the weight element can rotate freely in the receiving space only about the longitudinal axis of the latter.

In the method according to the disclosure, the sample is introduced into the receiving space, such that it is located between the weight element and the second or first end. The closure piece is then connected to the second end, and the sample tube is turned in such a way that the sample is located below the weight element in the direction of gravity. Finally, the sample tube is set in a rotational movement about the longitudinal axis of the receiving space.

On account of its moment of inertia, the weight element is set in rotation relative to the receiving space, and to a sample located in the receiving space, with a time delay. On account of the resulting difference in speed, the sample, which is arranged between the base or the closure piece and the weight element, is subjected to shear forces that disperse or homogenize the sample.

The sample tube has all the elements for dispersing or homogenizing a sample liquid, and therefore the use of the sample tube according to the disclosure prevents cross-over or contamination of the sample liquid. Moreover, the time needed for carrying out the dispersion or homogenization can be reduced considerably, since the sample only has to be introduced into the sample tube, and preparation or cleaning of additional equipment is not required.

On account of the friction with the closure piece or the cylindrical wall, a sample located in the receiving space is likewise set in rotational movement when the sample tube rotates, but with a time delay relative to the latter on account of the inertia. Finally, on account of the friction between the sample and the weight element, the weight element finally is also set in rotation, but likewise with a time delay in relation to the sample. As a result of this time delay, the rotational movement of the sample tube, of the sample and of the weight element takes place at different speeds. This results in force, in particular in the form of shear forces, being introduced into the sample.

The cylindrical wall of the sample tube is preferably made of a polymer material, in particular polypropylene, polystyrene or polyethylene terephthalate. Alternatively, however, the wall of the sample tube can also be made of glass.

The base of the sample tube is preferably flat. Alternatively, however, the base can also have a convex curvature or can be cone-shaped. The base is preferably designed in one piece with the cylindrical wall and is moreover preferably made of the same material.

The cylindrical wall is preferably transparent. Alternatively, however, the cylindrical wall can also be opaque, for example for the dispersion or homogenization of samples that contain light-sensitive substances. Moreover, the cylindrical wall can be non-transparent only for light of a defined spectrum, for example UV light.

The cylindrical wall preferably has a graduation or scale that allows the filling level of the sample tube to be read off. Moreover, the outside of the cylindrical wall can have a writing surface, which makes it possible to write on the sample tube.

The receiving space defines a volume for receiving a sample, in particular a sample liquid. The volume of the receiving space is preferably 100 μl to 500 ml, in particular 1 ml to 100 ml. However, special embodiments of the sample tube can also have receiving spaces with a smaller or greater volume.

The diameter of the cylindrical wall preferably measures 5 mm to 50 mm. The length of the sample tube, that is to say its maximum extent along the longitudinal axis, without the closure piece, preferably measures 10 mm to 250 mm. In special embodiments, the sample tube can be present in the form of a micro reaction vessel or a centrifuge tube.

The closure piece is preferably a screw-on or snap-on lid. Alternatively, however, the closure piece can also be in the form of a stopper, in particular of polyethylene. The closure piece is preferably made of the same material as the cylindrical wall. Alternatively, however, the closure piece can also be made of another material, in particular of another polymer. With the closure piece, the receiving space can preferably be closed in a liquid-tight manner at the second end.

The closure piece is connected releasably to the second end of the cylindrical wall, that is to say the closure piece can be removed from the second end without use of tools and without being destroyed. In preferred embodiments, the closure piece is connected to the cylindrical wall via a clip or the like, such that it cannot be lost in the released state.

The weight element preferably has a mass that is great enough to give rise to sufficiently high shear forces, during its movement relative to the cylindrical wall, to permit dispersion or homogenization, in particular cell disruption, of a sample located in the receiving space. The mass of the weight element is preferably from 5 g to 500 g.

The weight element preferably has a round cross section, which has a diameter slightly smaller than the diameter of the receiving space, such that it is able to rotate about its longitudinal axis inside the receiving space in a manner as free as possible from friction. The difference in diameter is preferably less than 1 mm, in particular less than 0.5 mm, such that only the smallest possible amount of liquid can pass between weight element and cylindrical wall when a liquid is received in the receiving space.

The weight element is shaped in such a way that it can rotate only about the longitudinal axis of the receiving space. This ensures particularly efficient dispersion and homogenization of a sample located in the receiving space.

The weight element can be made of the same material as the cylindrical wall. Preferably, however, the weight element is made of another material, in particular of glass, ceramic, metal or an alloy.

The sample tubes are preferably produced in such a way, and treated in such a way after their production, that they are sterile and in particular free of pyrogens, human DNA, RNase and/or DNase.

The materials from which the cylindrical wall, the base, the closure piece and the weight element are made are preferably non-cytotoxic.

Preferably, the weight element is initially located on the base such that, when a sample is received in the receiving space, said sample is located between weight element and closure piece. In this case, prior to the dispersion or homogenization, the sample tube is turned about such that the closure piece is facing downward. In this way, the weight element presses with its mass on the sample.

The sample tube preferably contains a liquid, in particular water or a buffer solution, which is in particular arranged between the weight element and the second end. The liquid is in particular preferably sterile.

The sample is preferably present in solid form. Alternatively, however, the sample can also be present as a sample liquid. If the sample is a sample liquid, cells are preferably suspended in the sample liquid. These can preferably be cells from humans, animals, insects, pants or fungi, and also bacteria, archaea, protozoa, yeasts or chimeras. If the sample is a solid sample, the sample is preferably a piece of tissue, in particular human or animal tissue, e.g. from a biopsy. Alternatively, however, a solid sample can also be a mineral, earth, a plant constituent or a foodstuff, for example a meat sample. A solid sample is preferably introduced together with water or a buffer solution into the receiving space.

The device preferably has a cover which encloses the at least one receptacle. By means of this cover, contamination of the surrounding air by aerosols can be eliminated. The cover preferably has a flap or door via which the at least one receptacle is accessible to a user of the device. The device preferably has a safety means that stops a rotational movement of the at least one receptacle when the flap or door is opened. The safety means can be of electronic or mechanical configuration.

The rotation of the sample tube is preferably an oscillating rotational movement. That is to say, the direction of rotation of the sample tube changes periodically. The sample tube is repeatedly accelerated and decelerated by the oscillating rotational movement, and the weight element, on account of its moment of inertia, follows these movements with a time delay. In some embodiments, depending on the moment of inertia and the periodicity of the oscillation, the rotation of weight element and sample tube can temporarily be in opposite directions, which provides a particularly high input of mechanical energy into the sample in the form of shear forces.

In an alternative embodiment, the rotation of the sample tube can also be intermittent. That is to say, the sample tube always rotates in the same direction, but with periodic acceleration and deceleration phases. On account of the moment of inertia, the weight element will always rotate at a speed different than that of the sample tube, whereby the input of mechanical energy or of shear forces into the sample can be increased.

The closure piece preferably has a first friction surface on a face which is directed toward the receiving space when the closure piece is connected to the second end. The input of mechanical energy into the sample can be additionally increased by the first friction surface.

The friction surface preferably has a surface structure that increases its static friction. The friction surface preferably has an increased roughness.

The weight element is preferably in the form of a cylinder that has a cross section smaller than the cross section of the receiving space. The design of the weight element as a cylinder provides the simplest possible design of the latter. The cylinder preferably has a thickness that is considerably smaller than the extent of the receiving space along the longitudinal axis. The thickness of the cylinder preferably measures from 2 mm to 40 mm.

Preferably, the weight element has a second friction surface on at least one face which is directed toward the first or second end. The input of mechanical energy into the sample can be additionally increased by the at least one second friction surface. If the weight element is a cylinder, the second friction surface is arranged on at least one of the end faces of the cylinder, but particularly preferably on both end faces.

Preferably, the first friction surface and if need be second friction surface on the at least one face of the weight element has structural elements, in particular teeth, pyramids or grooves. By means of structural elements such as these, it is possible to increase the energy input into the sample and in particular the generation of shear forces. The structural elements are preferably arranged in a regular pattern on the first friction surface and if need be on the second friction surface.

Preferably, the size, arrangement and geometry of the structural elements are adapted to the sample that is to be dispersed or homogenized. In other words, depending on the type of sample, another sample tube is made available that has suitable structural elements which permit optimal dispersion or homogenization of the sample.

Preferably, the weight element is made of glass, stainless steel, ceramic or a plastic. Weight elements made from these materials can be produced in large numbers with relatively little outlay and cost-effectively. Moreover, in particular glass, stainless steel and ceramic have a high inherent weight, as a result of which the mass of the weight element is particularly high, which leads to particularly efficient introduction of energy into the sample.

The present application further relates to a device for the dispersion or homogenization of a sample. The device comprises at least one receptacle for a sample tube according to the above description, which receptacle is able to be moved in a rotational movement by a drive of the device. The rotational movement is preferably an oscillating or intermittent rotational movement.

The at least one receptacle preferably has fastening means for allowing a sample tube to be fastened releasably to the receptacle. The fastening means are preferably present as form-fit means that have a shape complementing the base or the closure piece of the sample tube, such that a sample tube can be easily and reliably connected to the at least one receptacle. The form-fit means can be designed, for example, as a snap-on closure or screw-on closure.

Alternatively, however, the at least one receptacle can also have other fastening means with which a sample tube can be releasably connected to the receptacle by force-fit engagement, for example by means of magnets.

The device has at least one receptacle, but preferably more than one receptacle, for example two, three, four, five, six or more receptacles for a sample tube.

The drive for the at least one receptacle is preferably an electric motor, in particular a servo motor or a stepper motor. This provides for high dynamics of the drive, such that rapid changes of speed or direction of rotation and a high acceleration are possible even in the case of intermittent and oscillating rotational movements. The axis of rotation of the at least one receptacle is preferably formed by the axis of the motor, such that the receptacle is driven directly by the electric motor. Alternatively, the electric motor can act on the axis of rotation of the at least one receptacle via a transmission, in particular via a worm gear transmission or spur gear transmission.

If the device has more than one receptacle, each of the receptacles can preferably be set in the rotational movement about its own axis of rotation by the drive. In this case, the device preferably has a separate drive for each of the receptacles. Alternatively, however, all of the receptacles of the device can also be set in rotational movement via a transmission with a single drive. It is also conceivable that the total number of receptacles of the device are divided into groups, in which case all the receptacles of each group are each set in rotational movement by a common drive and via a corresponding transmission.

The device preferably has a control with which the drive of the at least one receptacle can be actuated. Moreover, the device preferably has input means, for example a key, with which in particular a user of the device can start the rotational movement. More preferably, the input means and if need be the control can be configured in such a way that a user can set the nature of the rotational movement and also parameters thereof, e.g. its duration, acceleration, etc. The device preferably has display means, e.g. a liquid crystal display, in order to be able to present data to a user of the device, for example parameters of the rotational movement, the already elapsed duration of the rotational movement or the status of the device. The device also has a port with which the device can be connected to a power supply.

The rotational movement is preferably centric. That is to say, the center of the receptacle lies on the axis of rotation thereof. Alternatively, however, the rotational movement can be eccentric. That is to say, the at least one receptacle is mounted in such a way that its rotation takes place eccentrically. The eccentric rotational movement has the effect that additional shear forces can be applied to the sample, as a result of which the efficiency of the dispersion or of the homogenization can be further increased.

The present application further relates to a combination of a device according to the above description and of at least one sample tube according to the disclosure.

Further advantageous embodiments and combinations of features of the disclosure can be gathered from the following detailed description and from the patent claims in their entirety.

### BRIEF DESCRIPTION OF THE DRAWINGS

In the drawings used to explain the illustrative embodiment:

FIG. 1 shows an embodiment of a sample tube according to the disclosure;

FIG. 2 shows a bottom view of the closure piece of the sample tube from FIG. 1;

FIG. 3 shows a schematic view of a device according to the disclosure for dispersion and homogenization.

In the figures, in principle, like parts are provided with like reference signs.

### DETAILED DESCRIPTION

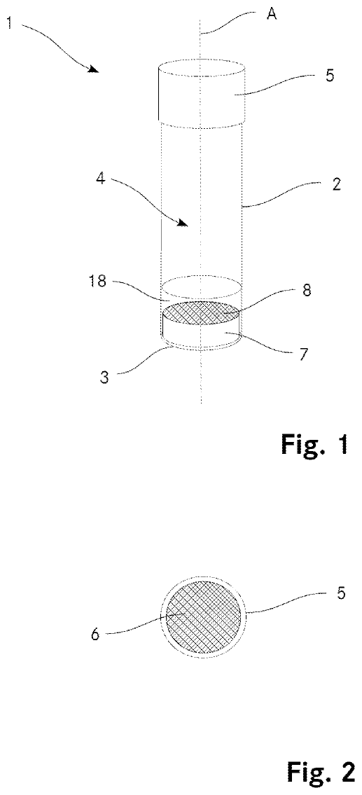

FIG. 1 shows an embodiment of a sample tube 1 according to the disclosure. The sample tube 1 has a cylindrical wall 2. A first end of the sample tube 1 is closed with a base 3. The cylindrical wall 2 and the base 3 define a receiving space 4 in which a sample can be received. At a second end, which lies opposite the first end, the sample tube has a closure piece 5 which, in the illustrative embodiment shown, is a screw-on lid. A weight element 7 is received inside the receiving space 4. The weight element 7 has a shape and size that allow it a rotation about the longitudinal axis A of the receiving space 4, but basically no further rotations about further axes. In the embodiment shown, the weight element 7 has a cylindrical shape. A movement of the weight element 7 along the longitudinal axis A of the receiving space 4 and slight movements along axes orthogonal to the longitudinal axis A are likewise possible. In the receiving space 4, the sample tube has a sterile liquid 18, which is located between the weight element 7 and the second end of the sample tube.

FIG. 1 shows the sample tube in a state in which it is standing vertically with its base 3 on a surface, that is to say the longitudinal axis A is parallel to the direction of gravity. Therefore, the weight element 7 correspondingly lies on the base 3. The weight element 7 has a second friction surface 8 on one of its end faces.

FIG. 2 shows a bottom view of the closure piece 5 in the form of the screw-on lid from FIG. 1. As will be seen, the closure piece 5 has a first friction surface 6 on its side pointing toward the receiving space 4 in the closed state. Both the first friction surface 6 of the closure piece and the second friction surface 8 of the weight element 7 have structural elements that increase the roughness of the first and second friction surfaces 6, 8.

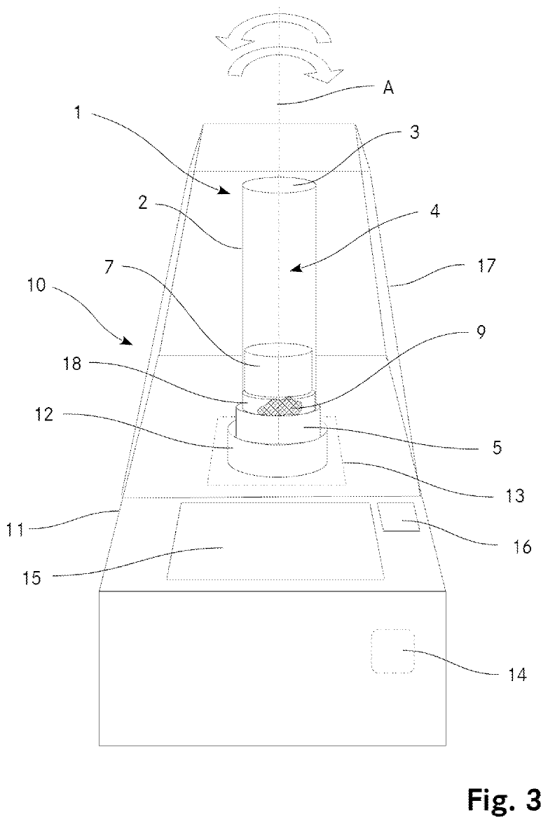

FIG. 3 shows a schematic view of a device 10 according to the disclosure for the dispersion or homogenization of a sample in combination with the sample tube 1 according to FIG. 1 and FIG. 2.

The device 10 has a housing 11 on which a receptacle 12 for the sample tube 1 is arranged. The receptacle 12 is designed in such a way that the closure piece 5 of the sample tube is partially inserted therein and is connected to it by form-fit engagement. The receptacle 12 is set in a rotational movement by a drive 13 of the device 10, which drive 13 is located in the housing 11 and is therefore only symbolized by dashed lines. By the rotational movement of the receptacle 12, the sample tube 1 connected to the latter is likewise set in the same rotational movement about the longitudinal axis A of the receiving space.

A sample 9 is received in the receiving space 4. In the embodiment shown, the sample 9 is a solid sample located in the liquid 18 of the sample tube 1. After the sample 9 has been introduced into the receiving space, the sample tube 1 is turned so that it can be fastened to the receptacle 12. As this is being done, the sample 9 slips or flows by gravity to that side of the closure piece 5 directed toward the receiving space 4. The weight element 7 in the receiving space will also slip by gravity along the longitudinal axis A in the direction of the closure piece. In this way, the sample 9 is enclosed between closure piece 5 and weight element 7.

The sample 9 is likewise set in rotational movement on account of the friction with the closure piece 5 and the cylindrical wall 2; however, on account of the inertia, this happens with a time delay relative to the rotational movement of the sample tube 1. On account of the friction between the sample 9 and the weight element 7, the weight element 7 is finally also set in rotational movement, but with a time delay relative to the sample 9. As a result of this time delay, the rotational movement of the sample tube 1, of the sample 9 and of the weight element 7 takes place at different speeds. This results in force being introduced into the sample, in particular in the form of shear forces. After some time, the rotational speeds equalize. Therefore, the device 10 has a control 14 (indicated by dashed lines) which is arranged inside the housing 11 and which controls the drive 13 of the receptacle 12 in such a way that the rotational movement is intermittent or oscillating. That is to say, there is a periodic change in the speed or in the direction of rotation. Thus, a difference in speed between the rotational movements of the sample tube 1, the sample 9 and the weight element 7 can be maintained in a substantially permanent manner.

The device 1 moreover has a display 15, on which parameters of the rotational movement of the receptacle can be displayed for example, and a key serving as input means 16, with which a user can initiate the start of the rotational movement. The device 1 further comprises a cover 17 which encloses the at least one receptacle 12.

What is claimed is:

1. A sample tube, comprising:
a cylindrical wall and a first end and a second end, the first end being closed by a base, such that a sample-receiving space with a longitudinal axis is formed between the base and a cylindrical wall, the second end having a closure piece connected releasably thereto, wherein a weight element is received inside the receiving space said weight element being shaped and dimensioned in such a way that the weight element can rotate freely in the receiving space only about the longitudinal axis of the latter.

2. The sample tube according to claim 1, wherein the closure piece has a first friction surface on a face which is directed toward the receiving space when the closure piece is connected to the second end.

3. The sample tube according to claim 1, wherein the weight element is in the form a cylinder that has a cross section smaller than the cross section of the receiving space.

4. The sample tube according to claim 1, wherein the weight element has a second friction surface on at least one face which is directed toward the first or second end.

5. The sample tube according to claim 2, wherein the first friction surface has structural elements, in particular teeth, pyramids or grooves.

6. The sample tube according to one of claim 1, wherein the weight element is made of glass, stainless steel, ceramic or a polymer.

7. A device for the dispersion or homogenization of a sample, comprising a housing with at least one receptacle for a sample tube according to claim 6, which receptacle is able to be moved in particular in an oscillating or intermittent rotational movement, by a drive of the device.

8. The device according to claim 7, wherein the rotational movement is centric.

9. Kit of parts comprising a device according to claim 7 and of at least one sample tube according to claim 1.

10. A method for the dispersion or homogenization of a sample, comprising the steps of:
a) providing a sample tube according to claim 1;
b) introducing the sample into the receiving space, such that the sample is located between weight element and first or second end;
c) connecting the closure piece to the second end;
d) turning the sample tube in such a way that the sample is located below the weight element in the direction of gravity; and
e) setting the sample tube in a rotational movement about a longitudinal axis of the receiving space.

11. The method according to claim 10, wherein the rotation of the sample tube is an oscillating rotational movement.

12. The method according to claim 10, wherein the rotation of the sample tube is performed intermittently.

13. The sample tube according to claim 4, wherein the second friction surface has structural elements, in particular teeth, pyramids or grooves.
